(19) United States
(12) Patent Application Publication
(10) Pub. No.: US 2025/0248577 A1
(43) Pub. Date: Aug. 7, 2025

(54) FILTRATION ASSEMBLY FOR CLEANING MACHINE

(71) Applicant: SlurryMonster, LLC, Livonia, MI (US)

(72) Inventor: Ryan Klacking, Canton, MI (US)

(21) Appl. No.: 19/042,295

(22) Filed: Jan. 31, 2025

Related U.S. Application Data
(60) Provisional application No. 63/549,017, filed on Feb. 2, 2024.

(51) Int. Cl. A47L 11/40; A47L 11/30; C02F 1/52; C02F 103/00

(52) U.S. Cl. CPC A47L 11/4022; A47L 11/30; A47L 11/4027; A47L 11/4044; A47L 11/4083; C02F 1/52; C02F 2103/002

(57) ABSTRACT

A floor cleaning machine includes a clean water tank, a floor scrubbing assembly in fluid communication with the clean water tank for engaging a floor surface, a debris collection assembly in fluid communication with a dirty water tank, and a pump operatively connected to the dirty water tank and the clean water tank. The pump is configured to transfer fluid from the dirty water tank to the clean water tank. A filter is fluidly between the dirty water tank and the clean water tank and configured to remove contaminants from the fluid flowing from the dirty water tank to the clean water tank.

### CROSS REFERENCED TO RELATED APPLICATIONS

This application claims priority to U.S. Provisional Application No. 63/549,017, filed Feb. 2, 2024.

### BACKGROUND

The present disclosure relates to a floor cleaning machine. Floor cleaning machines are mechanical devices designed to clean and maintain various types of floor surfaces efficiently and effectively. These machines may be used, for example, in commercial, industrial, and/or residential settings to save time and effort compared to manual cleaning methods.

### SUMMARY

In some aspects, the techniques described herein relate to a floor cleaning machine including: a clean water tank; a floor scrubbing assembly in fluid communication with the clean water tank for engaging a floor surface; a debris collection assembly in fluid communication with a dirty water tank; a pump operatively connected to the dirty water tank and the clean water tank, the pump configured to transfer fluid from the dirty water tank to the clean water tank; and a filter fluidly between the dirty water tank and the clean water tank and configured to remove contaminants from the fluid flowing from the dirty water tank to the clean water tank.

In some aspects, the techniques described herein relate to a machine, and the filter is fluidly downstream of the pump and upstream of the clean water tank.

In some aspects, the techniques described herein relate to a machine, including: a flocculant disposed in the dirty water tank.

In some aspects, the techniques described herein relate to a machine, including a mixer configured to cause a vortex within the dirty water tank to mix the flocculant with fluid disposed in the dirty water tank.

In some aspects, the techniques described herein relate to a machine, including a second pump configured to extract dirty water and debris from a floor surface and transfer the extracted dirty water and debris into the dirty water tank.

In some aspects, the techniques described herein relate to a machine, including: a flocculant disposed in the dirty water tank, and the second pump is configured to generate a positive pressure within the dirty water tank to agitate fluid within the dirty water tank for contact with the flocculant.

In some aspects, the techniques described herein relate to a machine, including: a skimmer configured to float on top of fluid within the dirty water tank, and the pump is configured to draw fluid from the dirty water tank through the skimmer.

In some aspects, the techniques described herein relate to a machine, including: a floor sink; a sink filter disposed within the floor sink; and a three way valve configured to draw fluid pumped by the pump to the floor sink.

In some aspects, the techniques described herein relate to a machine, and the scrubber assembly includes at least one brush head.

In some aspects, the techniques described herein relate to a machine, and the debris collection assembly includes a squeegee.

In some aspects, the techniques described herein relate to a method, including: providing water from a clean water tank to a scrubber assembly of a floor cleaning machine; scrubbing a floor surface with the scrubber assembly; collecting fluid from the floor surface to a dirty water tank on the floor cleaning machine; and pumping the fluid from the dirty water tank through a filter to the clean water tank.

In some aspects, the techniques described herein relate to a method, including: providing a flocculant within the dirty water tank.

In some aspects, the techniques described herein relate to a method, including: agitating the fluid within the dirty water tank for contact with the flocculant.

In some aspects, the techniques described herein relate to a method, and the agitating includes generating a vortex within the dirty water tank.

In some aspects, the techniques described herein relate to a method, and the agitating and the collecting steps are performed by the same pump.

In some aspects, the techniques described herein relate to a method, including: providing water from the clean water tank to the scrubber assembly after the pumping step.

In some aspects, the techniques described herein relate to a method, and the collecting step includes collecting fluid from the floor surface to a dirty water tank with a squeegee and a pump on the floor cleaning machine.

In some aspects, the techniques described herein relate to a method, including: providing a flocculant within the dirty water tank; agitating the fluid within the dirty water tank for contact with the flocculant, and the agitating and the collecting steps are performed by the same pump; and providing water from the clean water tank to the scrubber assembly after the pumping step, and the collecting step includes collecting fluid from the floor surface to a dirty water tank with a squeegee and a pump on the floor cleaning machine

In some aspects, the techniques described herein relate to a floor cleaning machine including: a clean water tank; a floor scrubbing assembly including at least one brush head and in fluid communication with the clean water tank for engaging a floor surface; a debris collection assembly including a squeegee and in fluid communication with a dirty water tank; a first pump operatively connected to the dirty water tank and the clean water tank, the pump configured to transfer fluid from the dirty water tank to the clean water tank; a skimmer configured to float on top of fluid within the dirty water tank, and the pump is configured to draw fluid from the dirty water tank through the skimmer; a flocculant disposed in the dirty water tank; a second pump configured to extract dirty water and debris from a floor surface and transfer the extracted dirty water and debris into the dirty water tank; and a filter fluidly between the dirty water tank and the clean water tank and configured to remove contaminants from the fluid flowing from the dirty water tank to the clean water tank.

These and other features may be best understood from the following specification and drawings, the following of which is a brief description.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 schematically illustrates a side view of an example floor cleaning machine.

FIG. 2 schematically illustrates a top view of the floor cleaning machine of FIG. 1.

FIG. 3 schematically illustrates a method of operating the floor cleaning machine of FIG. 1.

FIG. 4A schematically illustrates a top view of an example filter.

FIG. 4B schematically illustrates an end view of the filter of FIG. 4A.

FIG. 5 schematically illustrates a top view of a floor sink.

FIG. 6 schematically illustrates a cross-sectional view of the floor sink along line 6-6 of FIG. 5.

### DETAILED DESCRIPTION

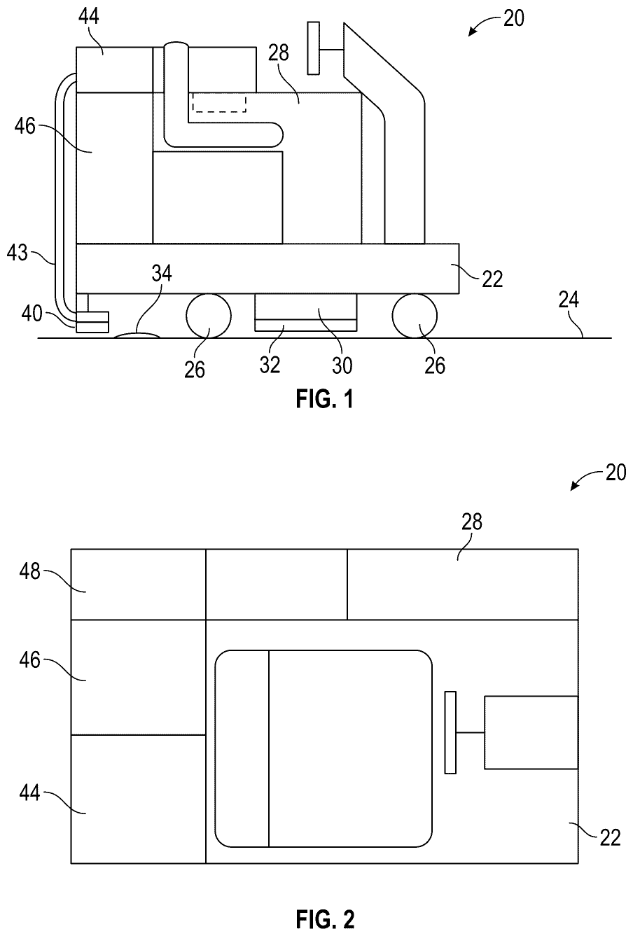

FIGS. 1 and 2 schematically illustrate an example floor cleaning machine 20. The machine 20 includes a frame 22 movable along a floor surface 24 on a plurality of wheels 26. The machine 20 includes a clean water tank 28 that provides clean water to a scrubber assembly 30 located below the frame 22. A debris collector 40, such as a squeegee assembly, collects debris 34 from the floor surface 24 during cleaning and directs it in the waste water tank 46. The debris 34 can then be treated and transferred back to the clean water tank 28 for use again with the scrubber assembly 30 as will be described in greater detail below. One benefit of this disclosure is the ability to extend the useful operating period for the machine 20 without needing to empty the waste water tank 46 or refill the clean water tank 28 as often.

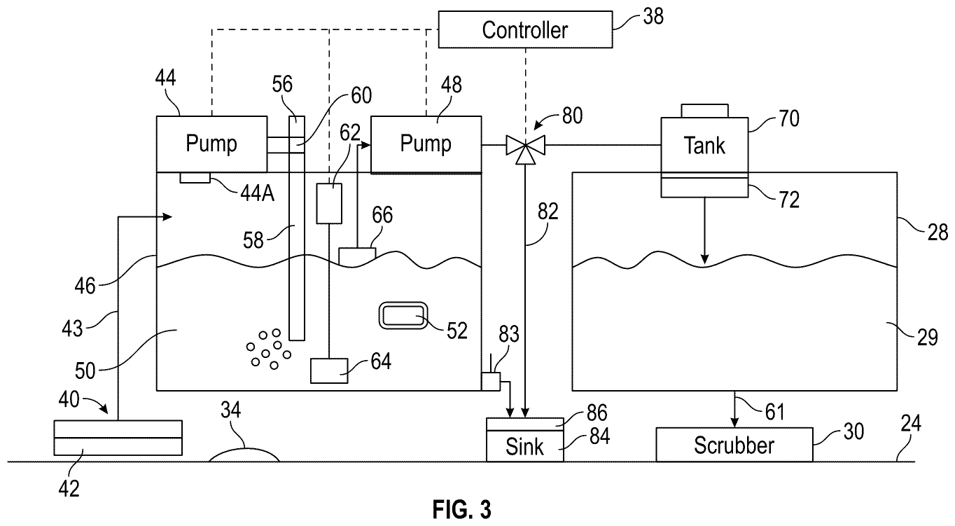

FIG. 3 schematically illustrates a method of operating the floor cleaning machine 20. Clean water 29 from the clean water tank 28 is directed to the scrubber assembly 30 through a clean water line 61. The scrubber assembly 30 utilizes at least one brush head 32 (FIG. 1) to agitate the floor surface 24 with the clean water 29 from the clean water tank 28 to lift debris 34 from the floor surface 24. The clean water 29 may also include the addition of a cleaning solution, such as a soap or a disinfectant, to aid in cleaning the floor surface 24 and to eliminate or reduce the formation of germs in the clean water 29. The agitation by the brush head 32 creates the debris 34 on the floor surface 24 that collects downstream of the scrubber assembly 30 during operation of the machine 20 along the floor surface 24.

The debris 34 formed from the scrubber assembly 30 is collected by a debris collector 40, such as a squeegee assembly that includes a squeegee 42 in contact with the floor surface 24, to direct the debris 34 to a central region of the debris collector 40. The collection of debris 34 by the debris collector 40 is evacuated by a suction hose 43 into the waste water tank 46. The suction hose 43 evacuates the debris 34 by a negative pressure differential generated from a pump inlet 44A within the waste water tank 46.

The debris 34 in the waste water tank 46 is largely in liquid form with solid particles suspended therein. For example, the debris 34 could include a slurry material with cement or dirt particles suspended in the liquid. Because these particles are in the waste water 50, the waste water 50 is no longer suitable for cleaning the floor surface 24 . . . . Therefore, the machine 20 can only be operated until the waste water tank 46 is full or the clean water tank 28 is empty, which requires an operator of the machine 20 to stop cleaning and remove the waste water 50 and refill the clean water tank 28. However, one benefit of the present disclosure is the ability to treat, filter, and then reuse the waste water 50 in the clean water tank 28. This allows for longer operation of the machine 20 such that the machine 20 can now clean more floor surface 24 in a shorter period of time.

The waste water 50 is initially treated with a flocculant material 52. In the illustrated example, the flocculant material 52 is shown in a water soluble package that allows waste water 50 to be treated with predetermined amounts of flocculant. The flocculant 52 allows the solid particles in the debris 34 to coagulate into larger particles that are easier to filter from the waste water 50 in the waste water tank 46.

The flocculant 52 can be mixed in the waste water tank 46 with at least one of several example methods. In one example, the flocculant 52 is mixed in the tank 46 by the motion of the waste water 50 generated by the machine 20 traveling along the floor surface 24. The sloshing motion of the waste water 50 causes the flocculant 52 to disperse through the waste water 50 and cause the smaller particles in the waste water 50 to join together into larger particles.

In another example, the positive pressure from the pump 44 can be diverted from the pump 44 into the waste water tank 46 to bubble the tank 46 or cause a vortex of the waste water 50 to form within the tank 46. The positive pressure from the pump 44 is directed between an outlet 56 or a bubble tube 58 through a valve 60. The valve 60 may be manually operated or an electromechanical valve in communication with a controller 38. The controller 38 can also be in electrical communication with the pumps 44 and 48 and the mixer 62 to perform the operations disclosed herein. The pumps disclosed herein may be automated or manually operated in implementations.

In a further example, a mixer 62 can be connected to a paddle 64 to cause a vortex and mix the flocculant 52 with the waste water 50. The rotation of the paddle 64 forms a vortex and mixes the flocculant 52 with the waste water 50.

A pump 48 can draw the waste water 50 from the tank 46 through a skimmer 66 that floats on top of the waste water 50. One feature of drawing the waste water 50 out of the tank 46 with the skimmer 66 is that the waste water 50 closest to the top is generally cleaner than the waste water 50 closer to the bottom of the tank 46.

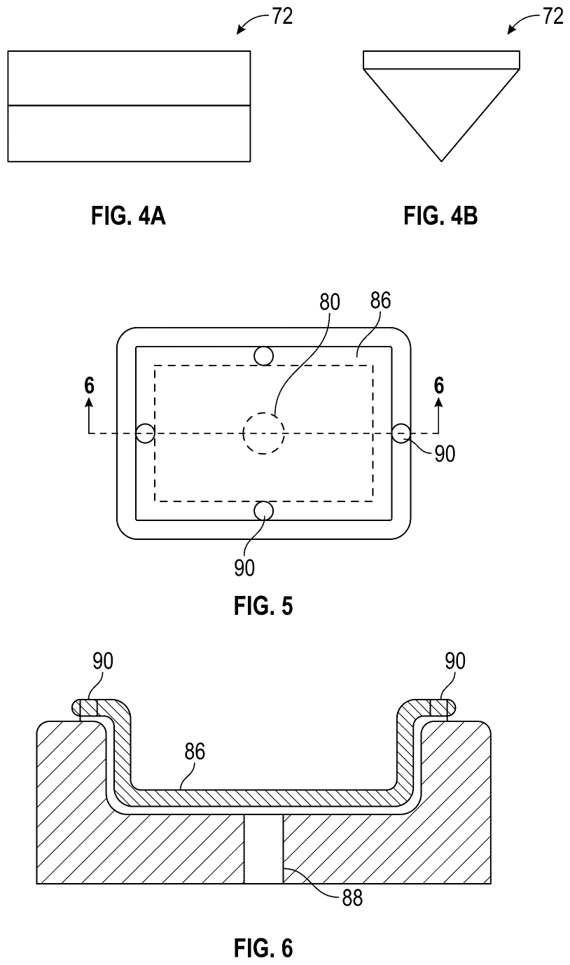

The waste water 50 taken from the waste water tank 46 is pumped into a holding tank 70 that allows the waste water 50 to be gravity fed through a filter 72 and back into the clean water tank 28. In the illustrated example, the filter 72 is an envelope filter forming a V-shaped pouch (FIGS. 4A-B) for collecting the waste water 50. In the illustrated example, the filter 72 is formed from a geotextile material.

Alternatively, a three-way valve 80 can direct the waste water 50 drawn by the pump 48 through a hose 82 into a floor sink 84, such as a janitor's sink, located adjacent the floor surface 24. The waste water 50 can also be drained into the sink 84 through a valve 83 located adjacent a base of the waste water tank 46. The sink 84 is lined with a sink filter 86 of similar or identical composition as the filter 72. However, the sink filter 86 includes a larger surface area as compared to the filter 72. One feature of the larger surface area of the filter 86 is the ability to clean a larger amount of waste water 50 before the filter 86 needs to be replaced. Additionally, the larger surface area of the filter 86 is able to collect more debris from the waste water 50 to prevent clogging of a drain 88 (FIGS. 5 and 6).

As shown in FIGS. 5 and 6, the filter 86 follows a contour of the sink 84 to allow the sink 84 to be at least partially filled with waste water 50 and still allow all of the waste water 50 to be filter with the assistance of gravity drawing the waste water 50 into the drain 88. The filter 86 can engage the sink 84 with a fastener 90, such as a suction cup or magnet, to secure the filter 86 relative to the sink to prevent the filter 86 from shifting during use.

A floor cleaning machine according to one or more examples in this disclosure may be said to include a clean water tank, a floor scrubbing assembly in fluid communication with the clean water tank for engaging a floor surface, a debris collection assembly in fluid communication with a dirty water tank, and a pump operatively connected to the dirty water tank and the clean water tank. The pump may be configured to transfer fluid from the dirty water tank to the clean water tank. A filter may be fluidly between the dirty water tank and the clean water tank and configured to remove contaminants from the fluid flowing from the dirty water tank to the clean water tank.

In one or more examples described in this disclosure, a floor cleaning machine may include a clean water tank and a floor scrubbing assembly that is in fluid communication with the clean water tank for cleaning a floor surface. The machine may also feature a debris collection assembly connected to a dirty water tank, along with a pump that operates between the dirty water tank and the clean water tank. The pump may be designed to transfer fluid from the dirty water tank to the clean water tank. A filter may be included to remove contaminants from the fluid as it flows from the dirty water tank to the clean water tank.

In implementations, the filter is fluidly downstream of the pump and upstream of the clean water tank.

In implementations, the machine includes a flocculant disposed in the dirty water tank. In implementations, the machine includes a mixer configured to cause a vortex within the dirty water tank to mix the flocculant with fluid disposed in the dirty water tank.

In implementations, the machine includes a second pump configured to extract dirty water and debris from a floor surface and transfer the extracted dirty water and debris into the dirty water tank. In implementations, the machine includes a flocculant disposed in the dirty water tank, and the second pump is configured to generate a positive pressure within the dirty water tank to agitate fluid within the dirty water tank for contact with the flocculant.

In implementations, the machine includes a skimmer configured to float on top of fluid within the dirty water tank, and the pump is configured to draw fluid from the dirty water tank through the skimmer.

In implementations, the machine includes a floor sink, a sink filter disposed within the floor sink, and a three way valve configured to draw fluid pumped by the pump to the floor sink.

In implementations, the scrubber assembly includes at least one brush head. In implementations, the debris collection assembly includes a squeegee.

A method according to one or more examples of this disclosure may be said to include one or more of the following steps: providing water from a clean water tank to a scrubber assembly of a floor cleaning machine; scrubbing a floor surface with the scrubber assembly; collecting fluid from the floor surface to a dirty water tank on the floor cleaning machine; and pumping the fluid from the dirty water tank through a filter to the clean water tank.

In implementations, the method includes providing a flocculant within the dirty water tank. In implementations, the method includes agitating the fluid within the dirty water tank for contact with the flocculant. In implementations, the agitating includes generating a vortex within the dirty water tank. In implementations, the agitating and the collecting steps are performed by the same pump.

In implementations, the method includes providing water from the clean water tank to the scrubber assembly after the pumping step.

In implementations, the collecting step includes collecting fluid from the floor surface to a dirty water tank with a squeegee and a pump on the floor cleaning machine.

In some embodiments, the techniques described herein pertain to a floor cleaning machine that includes: a clean water tank, and a floor scrubbing assembly with at least one brush head, which is in fluid communication with the clean water tank for cleaning a floor surface. A debris collection assembly may incorporate a squeegee and be in fluid communication with a dirty water tank. A first pump operatively connecting the dirty water tank and the clean water tank may be configured to transfer fluid between the tanks. A skimmer may be provided to float on the surface of the fluid within the dirty water tank, with the pump drawing fluid through the skimmer. A flocculant may be placed inside the dirty water tank. A second pump may be configured to extract dirty water and debris from the floor and deposit them into the dirty water tank. A filter may be provided to remove contaminants from the fluid as it moves between the tanks.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A floor cleaning machine comprising:
a clean water tank;
a floor scrubbing assembly in fluid communication with the clean water tank for engaging a floor surface;
a debris collection assembly in fluid communication with a dirty water tank;
a pump operatively connected to the dirty water tank and the clean water tank, the pump configured to transfer fluid from the dirty water tank to the clean water tank; and
a filter fluidly between the dirty water tank and the clean water tank and configured to remove contaminants from the fluid flowing from the dirty water tank to the clean water tank.

2. The machine of claim 1, wherein the filter is fluidly downstream of the pump and upstream of the clean water tank.

3. The machine of claim 1, comprising:
a flocculant disposed in the dirty water tank.

4. The machine of claim 3, comprising a mixer configured to cause a vortex within the dirty water tank to mix the flocculant with fluid disposed in the dirty water tank.

5. The machine of claim 1, comprising a second pump configured to extract dirty water and debris from a floor surface and transfer the extracted dirty water and debris into the dirty water tank.

6. The machine of claim 5, comprising:
a flocculant disposed in the dirty water tank, wherein the second pump is configured to generate a positive pressure within the dirty water tank to agitate fluid within the dirty water tank for contact with the flocculant.

7. The machine of claim 1, comprising:
a skimmer configured to float on top of fluid within the dirty water tank, wherein the pump is configured to draw fluid from the dirty water tank through the skimmer.

8. The machine of claim 1, comprising:
a floor sink;
a sink filter disposed within the floor sink; and
a three way valve configured to draw fluid pumped by the pump to the floor sink.

9. The machine of claim 1, wherein the floor scrubbing assembly comprises at least one brush head.

10. The machine of claim 1, wherein the debris collection assembly comprises a squeegee.

11. A method, comprising:
providing water from a clean water tank to a scrubber assembly of a floor cleaning machine;
scrubbing a floor surface with the scrubber assembly;
collecting fluid from the floor surface to a dirty water tank on the floor cleaning machine; and
pumping the fluid from the dirty water tank through a filter to the clean water tank.

12. The method of claim 11, comprising:
providing a flocculant within the dirty water tank.

13. The method of claim 12, comprising:
agitating the fluid within the dirty water tank for contact with the flocculant.

14. The method of claim 13, wherein the agitating includes generating a vortex within the dirty water tank.

15. The method of claim 13, wherein the agitating and the collecting steps are performed by the same pump.

16. The method of claim 11, comprising:
providing water from the clean water tank to the scrubber assembly after the pumping step.

17. The method of claim 11, wherein the collecting step includes collecting fluid from the floor surface to a dirty water tank with a squeegee and a pump on the floor cleaning machine.

18. The method of claim 11, comprising:
providing a flocculant within the dirty water tank;
agitating the fluid within the dirty water tank for contact with the flocculant, wherein the agitating and the collecting steps are performed by the same pump; and
providing water from the clean water tank to the scrubber assembly after the pumping step, wherein the collecting step includes collecting fluid from the floor surface to a dirty water tank with a squeegee and a pump on the floor cleaning machine.

19. A floor cleaning machine comprising:
a clean water tank;
a floor scrubbing assembly comprising at least one brush head and in fluid communication with the clean water tank for engaging a floor surface;
a debris collection assembly comprising a squeegee and in fluid communication with a dirty water tank;
a first pump operatively connected to the dirty water tank and the clean water tank, the pump configured to transfer fluid from the dirty water tank to the clean water tank;
a skimmer configured to float on top of fluid within the dirty water tank, wherein the pump is configured to draw fluid from the dirty water tank through the skimmer;
a flocculant disposed in the dirty water tank;
a second pump configured to extract dirty water and debris from a floor surface and transfer the extracted dirty water and debris into the dirty water tank; and
a filter fluidly between the dirty water tank and the clean water tank and configured to remove contaminants from the fluid flowing from the dirty water tank to the clean water tank.
